(19) United States
(12) Patent Application Publication
(10) Pub. No.: US 2026/0172833 A1
(43) Pub. Date: Jun. 18, 2026

(54) DETECTION DEVICE, DETECTION METHOD, AND DETECTION PROGRAM

(71) Applicants: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(72) Inventors: Kyosuke MASUKAWA, Osaka-shi, Osaka (JP); Yoshihiro HAMADA, Osaka-shi, Osaka (JP)

(73) Assignees: SUMITOMO ELECTRIC INDUSTRIES, LTD., Osaka-shi, Osaka (JP); SUMITOMO WIRING SYSTEMS, LTD., Yokkaichi-shi, Mie (JP); AUTONETWORKS TECHNOLOGIES, LTD., Yokkaichi-shi, Mie (JP)

(21) Appl. No.: 19/125,298

(22) PCT Filed: Jul. 21, 2023
(86) PCT No.: PCT/JP2023/026835

§ 371 Date: Apr. 28, 2025

(30) Foreign Application Priority Data
Nov. 18, 2022 (JP) 2022-184950

(51) Int. Cl. H04W 12/121; H04L 5/00; H04W 24/08; H04W 80/06

(52) U.S. Cl. CPC H04W 12/121; H04L 5/0053; H04W 24/08; H04W 80/06

(57) ABSTRACT

Provided is a detection device configured to detect presence of an unauthorized communication connection in a network. The detection device includes: a monitoring unit configured to monitor a communication connection that is established for exchanging a predetermined message in the network; and a detection unit configured to detect the presence of the unauthorized communication connection, based on a result of monitoring a plurality of the communication connections by the monitoring unit.

### TECHNICAL FIELD

The present disclosure relates to a detection device, a detection method, and a detection program.

This application claims priority on Japanese Patent Application No. 2022-184950 filed on Nov. 18, 2022, the entire content of which is incorporated herein by reference.

### BACKGROUND ART

Patent Literature 1 (International Publication No. WO2022/153839) discloses a detection device as follows. That is, the detection device is a device for detecting the presence of an unauthorized message in an in-vehicle network, and includes: a state detection unit that detects a transition to a state in which a periodic message is transmitted in the in-vehicle network, based on the content of a message transmitted in the in-vehicle network; and a processing unit that performs a detection process of detecting the presence of the unauthorized message, based on a reception status of a plurality of the periodic messages in the state detected by the state detection unit.

### CITATION LIST

### Patent Literature

Patent Literature 1: International Publication No. Wo2022/153839

### SUMMARY OF THE INVENTION

A detection device according to the present disclosure is a detection device configured to detect presence of an unauthorized communication connection in a network, and the detection device includes: a monitoring unit configured to monitor a communication connection that is established for exchanging a predetermined message in the network; and a detection unit configured to detect the presence of the unauthorized communication connection, based on a result of monitoring a plurality of the communication connections by the monitoring unit.

An aspect of the present disclosure can be realized not only as a detection device having such a characteristic processing unit, but also as a semiconductor integrated circuit that realizes a part or the entirety of the detection device, or as a system including the detection device.

### BRIEF DESCRIPTION OF DRAWINGS

FIG. 1 shows a configuration of a network according to an embodiment of the present disclosure.

FIG. 2 shows a configuration of a relay device according to the embodiment of the present disclosure.

FIG. 3 shows an example of messages transmitted and received in the network according to the embodiment of the present disclosure.

FIG. 4 shows another example of messages transmitted and received in the network embodiment of the present disclosure.

FIG. 5 shows an example of a communication connection operation of a monitoring target of a monitoring unit in the relay device according to the embodiment of the present disclosure.

FIG. 6 shows an example of a communication connection operation of a monitoring target of the monitoring unit in the relay device according to the embodiment of the present disclosure.

FIG. 7 shows an example of a communication connection operation of a monitoring target of the monitoring unit in the relay device according to the embodiment of the present disclosure.

FIG. 8 shows an example of a communication connection operation of a monitoring target of the monitoring unit in the relay device according to the embodiment of the present disclosure.

FIG. 9 shows an example of a communication connection operation of a monitoring target of the monitoring unit in the relay device according to the embodiment of the present disclosure.

FIG. 10 shows an example of a communication connection operation of a monitoring target of the monitoring unit in the relay device according to the embodiment of the present disclosure.

FIG. 11 shows an example of a communication connection operation of a monitoring target of the monitoring unit in the relay device according to the embodiment of the present disclosure.

FIG. 12 shows an example of a communication connection operation of a monitoring target of the monitoring unit in the relay device according to the embodiment of the present disclosure.

FIG. 13 is a flowchart showing an example of an operation procedure when the relay device according to the embodiment of the present disclosure monitors a communication connection.

FIG. 14 is a flowchart showing an example of an operation procedure when the relay device according to the embodiment of the present disclosure performs a detection process.

FIG. 15 is a flowchart showing an example of an operation procedure when the relay device according to the embodiment of the present disclosure performs a detection process.

FIG. 16 is a flowchart showing an example of an operation procedure when the relay device according to the embodiment of the present disclosure performs a detection process.

FIG. 17 is a flowchart showing an example of an operation procedure when the relay device according to the embodiment of the present disclosure performs a detection process.

FIG. 18 is a flowchart showing an example of an operation procedure when the relay device according to the embodiment of the present disclosure performs a detection process.

### DETAILED DESCRIPTION

To date, technologies for improving security in a network has been proposed.

### Problems to be Solved by the Present Disclosure

A technology that enables more accurate detection of the presence of an unauthorized communication connection in a network is desired beyond the technology described in Patent Literature 1.

The present disclosure is made to solve the above problem, and an object of the present disclosure is to provide a detection system, a verification device, a response device, and a detection method capable of accurately detecting the presence of an unauthorized communication connection in a network.

### Effects of the Present Disclosure

According to the present disclosure, it is possible to accurately detect the presence of an unauthorized communication connection in a network.

### Description of Embodiment of the Present Disclosure

First, the contents of the embodiment of the present disclosure are listed and described.
(1) A detection device according to an embodiment of the present disclosure is a detection device configured to detect presence of an unauthorized communication connection in a network, and the detection device includes: a monitoring unit configured to monitor a communication connection that is established for exchanging a predetermined message in the network; and a detection unit configured to detect the presence of the unauthorized communication connection, based on a result of monitoring a plurality of the communication connections by the monitoring unit.

In the configuration in which the presence of an unauthorized communication connection is detected based on a result of monitoring a plurality of communication connections, it is possible to determine that an unauthorized communication connection exists, when the communication connection state in the network has been changed due to establishment of an unauthorized communication connection, for example. Thus, the presence of an unauthorized communication connection in the network can be more accurately detected.
(2) In the above (1), the detection unit may detect the presence of the unauthorized communication connection, based on a cycle at which the communication connection is established.

In the above configuration, it is possible to detect an unauthorized communication connection, based on a change in the cycle of communication connection occurrence due to establishment of an unauthorized communication connection.
(3) In the above (1) or (2), the detection unit may detect the presence of the unauthorized communication connection, based on a frequency at which the communication connection is established.

In the above configuration, it is possible to detect an unauthorized communication connection, based on a change in the frequency of communication connection occurrence due to establishment of an unauthorized communication connection.
(4) In any one of the above (1) to (3), the detection unit may detect the presence of the unauthorized communication connection, based on a ratio of a period during which the communication connection is established, to a unit time.

In the above configuration, it is possible to detect an unauthorized communication connection, based on a change, in the period during which a communication connection is established per unit time, due to establishment of the unauthorized communication connection.
(5) In any one of the above (1) to (4), the monitoring unit may monitor the communication connection that is established by using a Subscribe Ack message conforming to SOME/IP (Scalable service-Oriented MiddlewarE over IP), and is ended by using a Stop Offer message or a Stop Subscribe message conforming to SOME/IP.

In the above configuration, the presence of an unauthorized communication connection can be more accurately detected in the network in which messages are transmitted and received according to SOME/IP.
(6) In any one of the above (1) to (4), the monitoring unit may monitor a TCP (Transmission Control Protocol) connection as the communication connection.

In the above configuration, the presence of an unauthorized communication connection can be more accurately detected in the network in which messages are transmitted and received according to TCP.
(7) In any one of the above (1) to (4), the monitoring unit may monitor the communication connection that is established by using a create_subscriber message conforming to DDS (Data Distribution Service), and is ended by using a Delete_subscriber message conforming to DDS.

In the above configuration, the presence of an unauthorized communication connection can be more accurately detected in the network in which messages are transmitted and received according to DDS.
(8) A detection method according to the embodiment of the present disclosure is a detection method in a detection device that detects presence of an unauthorized communication connection in a network, and the method includes: monitoring a communication connection that is established for exchanging a predetermined message in the network; and detecting the presence of the unauthorized communication connection, based on a result of monitoring a plurality of the communication connections.

In the method in which the presence of an unauthorized communication connection is detected based on a result of monitoring a plurality of communication connections, it is possible to determine that an unauthorized communication connection exists, when the communication connection state in the network has been changed due to establishment of an unauthorized communication connection, for example. Thus, the presence of an unauthorized communication connection in the network can be more accurately detected.
(9) A detection program according to the embodiment of the present disclosure is a detection program used in a detection device that detects presence of an unauthorized communication connection in a network, and the program causes a computer to function as: a monitoring unit configured to monitor a communication connection that is established for exchanging a predetermined message in the network; and a detection unit configured to detect the presence of the unauthorized communication connection, based on a result of monitoring a plurality of the communication connections by the monitoring unit.

In the configuration in which the presence of an unauthorized communication connection is detected based on a result of monitoring a plurality of communication connections, it is possible to determine that an unauthorized communication connection exists, when the communication connection state in the network has been changed due to establishment of an unauthorized communication connection, for example. Thus, the presence of an unauthorized communication connection in the network can be more accurately detected.

Hereinafter, an embodiment of the present disclosure will be described with reference to the drawings. In the drawings, the same or corresponding parts are denoted by the same reference signs, and description thereof is not repeated. At least some parts of the embodiment described below may be combined as desired.

### Configuration and Basic Operation

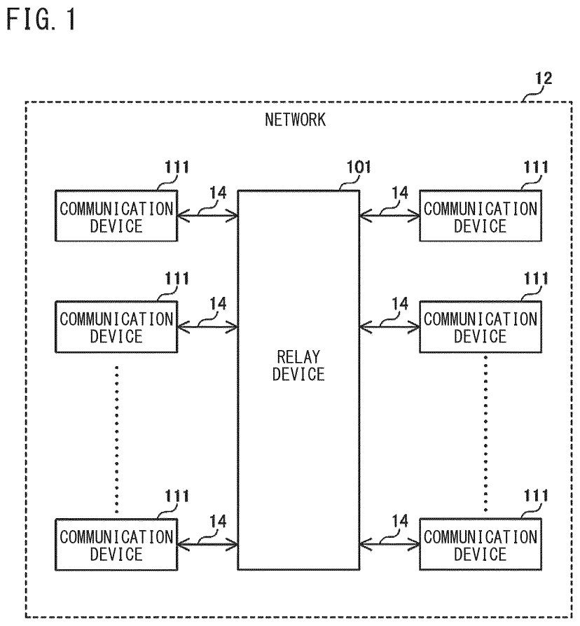

FIG. 1 shows a configuration of a network according to the embodiment of the present disclosure. With reference to FIG. 1, a network 12 includes a relay device 101 and a plurality of communication devices 111. The communication devices 111 are connected to the relay device 101 via transmission lines 14. Each transmission line 14 is, for example, an Ethernet (registered trademark) cable.

For example, the network 12 is an in-vehicle network. In this case, the communication devices 111 are in-vehicle ECUs (Electronic Control Units). Specifically, examples of the communication devices 111 include an electric power steering (EPS), a brake control device, an accelerator control device, a steering control device, a driver-assistance device that provides instructions to various devices in an advanced driver-assistance system (ADAS), and a sensor.

The network 12 may be a network in an industrial control system such as a factory or a plant. In this case, examples of the communication devices 111 include a power supply controller, a robot, a sensor, and a programmable logic controller (PLC) for actuator control.

Each communication device 111 transmits and receives a message to and from another communication device 111 by establishing a communication connection for exchanging a predetermined message according to a connection type protocol. More specifically, the communication device 111 periodically or non-periodically establishes a communication connection with another communication device 111. Then, the communication device 111 generates a frame including a message and addressed to the other communication device 111, and transmits the generated frame to the relay device 101 via the transmission line 14, For example, the communication device 111 can dynamically establish communication connections with a plurality of different communication devices 111.

The relay device 101 is, for example, a central gateway (CGW), and performs a relay process of relaying messages transmitted and received between a plurality of communication devices 111 connected to different transmission lines 14. More specifically, the relay device 101 receives the frame transmitted from the communication device 111 via the corresponding transmission line 14, and transmits the received frame to the destination communication device 111 via the corresponding transmission line 14.

Moreover, the relay device 101 functions as a detection device, and performs a detection process of detecting the presence of a communication connection not authorized in the network 12. Hereinafter, such a communication connection not authorized in the network 12 is also referred to as “unauthorized communication connection”.

### <Relay Device>

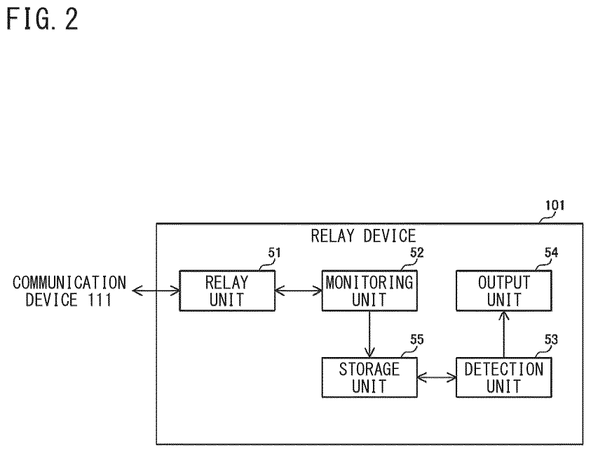

FIG. 2 shows the configuration of the relay device according to the embodiment of the present disclosure. With reference to FIG. 2, the relay device 101 includes a relay unit 51, a monitoring unit 52, a detection unit 53, an output unit 54, and a storage unit 55. Some or all of the relay unit 51, the monitoring unit 52, the detection unit 53, and the output unit 54 are realized by processing circuitry including one or more processors, for example. The storage unit 55 is, for example, a non-volatile memory included in the processing circuitry.

The relay unit 51 receives a frame from a certain communication device 111 via the corresponding transmission line 14, and transmits the received frame to a destination communication device 111 according to destination information of this frame via the corresponding transmission line 14. Here, the destination information of the frame is information indicating the destination of the frame, such as a destination MAC address, a destination IP address, or a message ID.

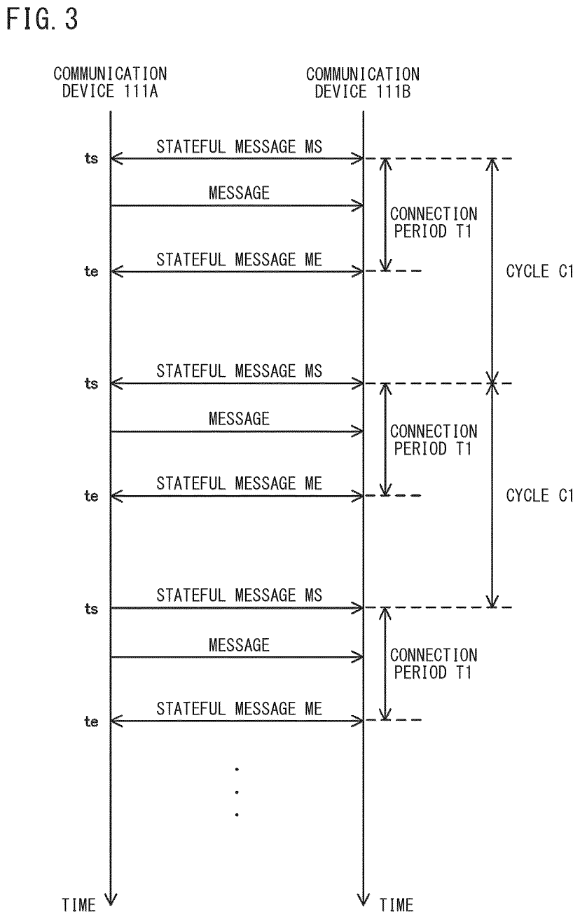

FIG. 3 shows an example of messages transmitted and received in the network according to the embodiment of the present disclosure. FIG. 3 is a time chart indicating messages transmitted and received by communication devices 111A, 111B being communication devices 111.

With reference to FIG. 3, the communication device 111A establishes a communication connection with the communication device 111B by exchanging one or more stateful messages MS, which are messages for establishing a communication connection with another communication device 111, with the communication device 111B via the relay device 101. In addition, the communication device 111A ends the communication connection with the communication device 111B by exchanging one or more stateful messages ME, which are messages for ending a communication connection with another communication device 111, with the communication device 111B via the relay device 101. The communication device 111A transmits one or more messages to the communication device 111B via the relay device 101 during a connection period T1 in which the communication connection with the communication device 111B is established.

Of the communication device 111A and the communication device 111B, only the communication device 111A may establish the communication connection by transmitting the stateful message MS to the communication device 111B via the relay device 101. Of the communication device 111A and the communication device 111B, only the communication device 111A may end the communication connection by transmitting the stateful message ME to the communication device 111B via the relay device 101. The communication device 111B may transmit the message to the communication device 111A via the relay device 101 during the connection period T1.

The monitoring unit 52 monitors a communication connection established in the network 12. More specifically, the monitoring unit 52 monitors the relay process performed by the relay unit 51, and refers to header information of the frame received by the relay unit 51 to confirm the content of the message stored in the frame.

When the message stored in the frame received by the relay unit 51 is a stateful message MS, the monitoring unit 52 determines that a communication connection between a communication device 111 as a source of the stateful message MS and a communication device 111 as a destination of the stateful message MS is established. For example, the monitoring unit 52 acquires a reception time ts, by the relay unit 51, of the frame in which the stateful message MS is stored, and stores the acquired reception time ts in the storage unit 55.

When the message stored in the frame received by the relay unit 51 is a stateful message ME, the monitoring unit 52 determines that a communication connection between a communication device 111 as a source of the stateful message ME and a communication device 111 as a destination of the stateful message ME is ended. For example, the monitoring unit 52 acquires a reception time te, by the relay unit 51, of the frame in which the stateful message ME is stored, and stores the acquired reception time te in the storage unit 55.

The detection unit 53 detects the presence of an unauthorized communication connection, based on a result of monitoring a plurality of communication connections by the monitoring unit 52. For example, the detection unit 53 detects the presence of an unauthorized communication connection, based on a result of monitoring a plurality of communication connections in a set of two communication devices 111.

For example, the detection unit 53 detects the presence of an unauthorized communication connection, based on at least one of: a cycle C1 at which a communication connection between communication devices 111 is established; a frequency F1 at which a communication connection between communication devices 111 is established; and a ratio R1 of a connection period T1 to a unit time.

More specifically, the detection unit 53 calculates the cycle C1 and the frequency F1, based on a plurality of reception times ts that are stored in the storage unit 55 by the monitoring unit 52. In addition, the detection unit 53 calculates the connection period T1 based on the reception times ts, te stored in the storage unit 55 by the monitoring unit 52, and calculates the ratio R1 based on the connection period T1.

The detection unit 53 detects the presence of an unauthorized communication connection, based on at least one of the calculated cycle C1, frequency F1, and ratio R1. Upon detecting that an unauthorized communication connection is present, the detection unit 53 outputs the detection result to the output unit 54.

The output unit 54 receives, from the detection unit 53, the detection result indicating that an unauthorized communication connection is detected, and outputs an alarm indicating that the unauthorized communication connection is detected, to the user's terminal or the like via a communication device 111 having a wireless communication function, for example.

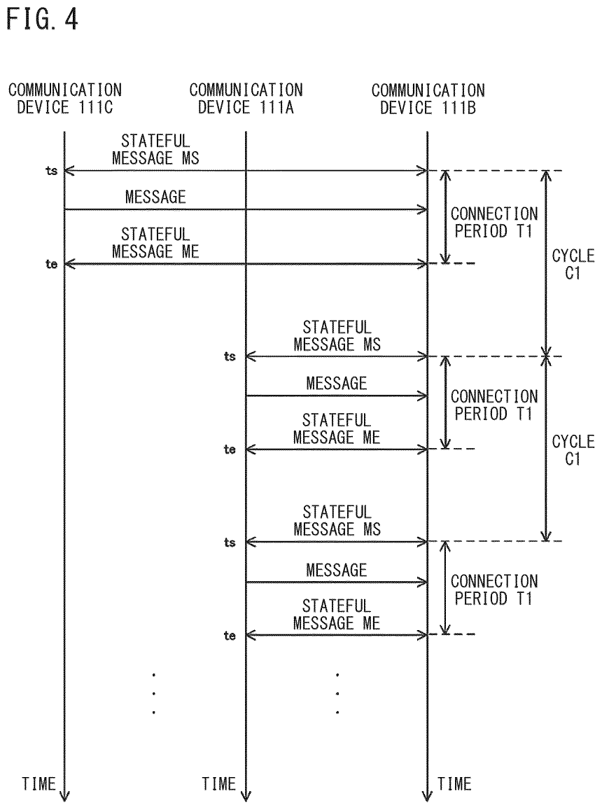

FIG. 4 shows another example of messages transmitted and received in the network according to the embodiment of the present disclosure. FIG. 4 is a time chart showing messages transmitted and received by communication devices 111A, 111B, 111C being communication devices 111.

With reference to FIG. 4, in addition to the communication device 111A, the communication device 111C establishes a communication connection with the communication device 111B by exchanging one or more stateful messages MS, which are messages for establishing a communication connection with another communication device 111, with the communication device 111B via the relay device 101. In addition, the communication device 111C ends the communication connection with the communication device 111B by exchanging one or more stateful messages ME, which are messages for ending a communication connection with another communication device 111, with the communication device 111B via the relay device 101.

In this case, for example, the detection unit 53 detects the presence of an unauthorized communication connection, based on a result of monitoring a plurality of communication connections in a set of a plurality of different communication devices 111 More specifically, the detection unit 53 calculates the cycle C1, based on a reception time ts of a frame in which the stateful message MS transmitted by the communication device 111C is stored, and a reception time ts of a frame in which the stateful message MS transmitted by the communication device 111A is stored. In addition, the detection unit 53 calculates the frequency F1, based on the number of times the communication connection between the communication device 111A and the communication device 111B is established, and the number of times the communication connection between the communication device 111C and the communication device 111B is established. Moreover, the detection unit 53 calculates the ratio R1, based on the connection period T1 of the communication connection between the communication device 111A and the communication device 111B, and the connection period T1 of the communication connection between the communication device 111A and the communication device 111B.

### Specific Example 1 of Detection Process

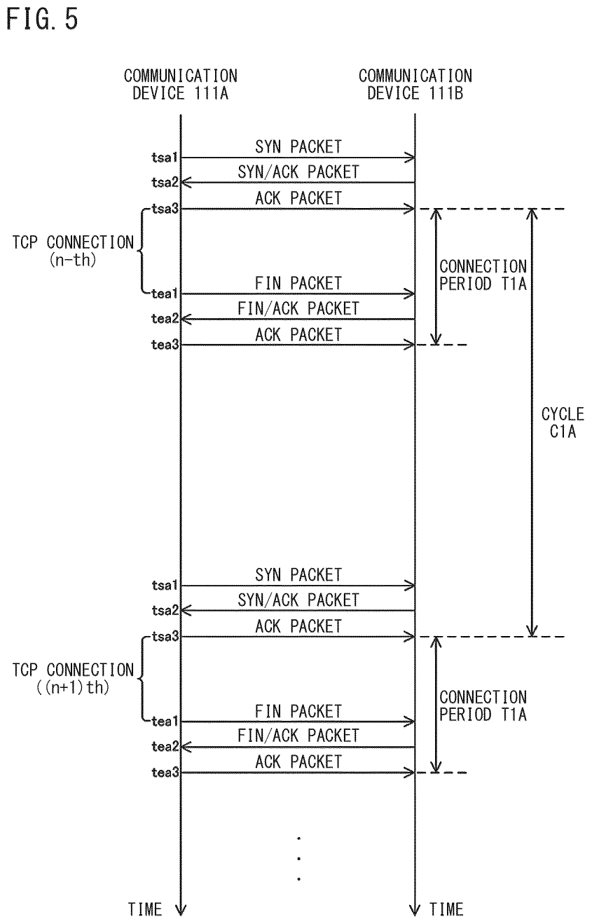

FIG. 5 shows an example of a communication connection operation of a monitoring target of the monitoring unit in the relay device according to the embodiment of the present disclosure. FIG. 5 shows a time chart of messages transmitted and received by the communication devices 111A, 111B being communication devices 111.

With reference to FIG. 5, in the network 12, messages are transmitted and received according to TCP/IP, The communication device 111 establishes a TCP connection that is a communication connection according to TCP/IP by a 3-way handshake.

More specifically, the communication device 111A generates an SYN packet that is a TCP packet in which an SYN flag in a TCP header is set to ON, and transmits the generated SYN packet to the communication device 111B via the relay device 101.

The communication device 111B receives the SYN packet from the communication device 111A via the relay device 101, generates an SYN/ACK packet that is a TCP packet in which an SYN flag and an ACK flag in a TCP header are set to ON, and transmits the generated SYN/ACK packet to the communication device 111A via the relay device 101.

The communication device 111A receives the SYN/ACK packet from the communication device 111B via the relay device 101, generates an ACK packet that is a TCP packet in which an ACK flag in a TCP header is set to ON, and transmits the generated ACK packet to the communication device 111B via the relay device 101. Thus, the n-th TCP connection between the communication device 111A and the communication device 111B is established. The SYN packet, the SYN/ACK packet, and the ACK packet in the 3-way handshake are examples of the stateful message MS.

When ending the TCP connection with the communication device 111B, the communication device 111A generates an FIN packet that is a TCP packet in which an FIN flag in a TCP header is set to ON, and transmits the generated FIN packet to the communication device 111B via the relay device 101.

The communication device 111B receives the FIN packet from the communication device 111A via the relay device 101, generates an FIN/ACK packet that is a TCP packet in which an FIN flag and an ACK flag in a TCP header are set to ON, and transmits the generated FIN/ACK packet to the communication device 111A via the relay device 101.

The communication device 111A receives the FIN/ACK packet from the communication device 111B via the relay device 101, generates an ACK packet that is a TCP packet in which an ACK flag in a TCP header is set to ON, and transmits the generated ACK packet to the communication device 111B via the relay device 101. Thus, the TCP connection between the communication device 111A and the communication device 111B is ended. The FIN packet, the FIN/ACK packet, and the ACK packet in the 3-way handshake are examples of the stateful message ME.

The communication device 111A transmits one or more messages to the communication device 111B via the relay device 101 during a connection period T1A that is the connection period T1 of the TCP connection with the communication device 111B.

Thereafter, establishment and ending of a TCP connection between the communication device 111A and the communication device 111B are repeated in a similar manner.

The monitoring unit 52 monitors a TCP connection as an example of a communication connection established in the network 12. For example, the monitoring unit 52 monitors the TCP connection established in the network 12 for each application that is specified by a set of port numbers.

More specifically, if an SYN packet is stored in a frame received by the relay unit 51, the monitoring unit 52 determines that a TCP connection between the communication device 111 as the source of the frame and the communication device 111 as the destination of the frame is established.

Then, the monitoring unit 52 acquires a source port number and a destination port number from the TCP header of the SYN packet, and stores, in the storage unit 55, the acquired set of the source port number and the destination port number as identification information DA indicating the communication connection as a monitoring target. In addition, the monitoring unit 52 generates state information indicating that the state of the communication connection as the monitoring target has transitioned to the state in which the SYN packet has been exchanged, and stores, in the storage unit 55, the generated state information in association with the identification information DA. In addition, the monitoring unit 52 acquires a reception time tsa1 that is the reception time ts, by the relay unit 51, of the frame in which the SYN packet is stored, and stores, in the storage unit 55, the acquired reception time tsa1 in association with the identification information DA. The reception time tsa1 corresponds to the time at which the state of the communication connection as the monitoring target has transitioned to the state in which the SYN packet has been exchanged.

If an SYN/ACK packet is stored in a frame received by the relay unit 51, the monitoring unit 52 acquires a source port number and a destination port number from a TCP header of the SYN/ACK packet, and specifies identification information DA that matches the acquired set of the source port number and the destination port number from among pieces of identification information DA stored in the storage unit 55. Then, the monitoring unit 52 updates the state information corresponding to the specified identification information DA to state information indicating that transition has been made to the state in which the SYN/ACK packet has been exchanged. In addition, the monitoring unit 52 acquires a reception time tsa2 that is a reception time ts, by the relay unit 51, of the frame in which the SYN/ACK packet is stored, and stores, in the storage unit 55, the acquired reception time tsa2 in association with the specified identification information DA. The reception time tsa2 corresponds to the time at which the state of the communication connection as the monitoring target has transitioned to the state in which the SYN/ACK packet has been exchanged.

If an ACK packet is stored in a frame received by the relay unit 51, the monitoring unit 52 acquires a source port number and a destination port number from a TCP header of the ACK packet, and specifies identification information DA that matches the acquired set of the source port number and the destination port number from among pieces of identification information DA stored in the storage unit 55. Then, the monitoring unit 52 updates the state information corresponding to the specified identification information DA to state information indicating that transition has been made to the state in which the ACK packet for the SYN/ACK packet has been exchanged. In addition, the monitoring unit 52 acquires a reception time tsa3 that is a reception time ts, by the relay unit 51, of the frame in which the ACK packet is stored, and stores, in the storage unit 55, the acquired reception time tsa3 in association with the specified identification information DA. The reception time tsa3 corresponds to the time at which the state of the communication connection as the monitoring target has transitioned to the state in which the ACK packet for the SYN/ACK packet has been exchanged.

If an FIN packet is stored in a frame received by the relay unit 51, the monitoring unit 52 acquires a source port number and a destination port number from a TCP header of the FIN packet, and specifies identification information DA that matches the acquired set of the source port number and the destination port number from among pieces of identification information DA stored in the storage unit 55. Then, the monitoring unit 52 updates the state information corresponding to the specified identification information DA to state information indicating that transition has been made to the state in which the FIN packet has been exchanged. In addition, the monitoring unit 52 acquires a reception time tea1 that is a reception time te of the frame in which the FIN packet is stored, and stores, in the storage unit 55, the acquired reception time tea1 in association with the specified identification information DA. The reception time tea1 corresponds to the time at which the state of the communication connection as the monitoring target has transitioned to the state in which the FIN packet has been exchanged.

If an FIN/ACK packet is stored in a frame received by the relay unit 51, the monitoring unit 52 acquires a source port number and a destination port number from a TCP header of the FIN/ACK packet, and specifies identification information DA that matches the acquired set of the source port number and the destination port number from among pieces of identification information DA stored in the storage unit 55. Then, the monitoring unit 52 updates the state information corresponding to the specified identification information DA to state information indicating that transition has been made to the state in which the FIN/ACK packet has been exchanged. Then, the monitoring unit 52 acquires a reception time tea2 that is a reception time te of the frame in which the FIN/ACK packet is stored, and stores, in the storage unit 55, the acquired reception time tea2 in association with the specified identification information DA. The reception time tea2 corresponds to the time at which the state of the communication connection as the monitoring target has transitioned to the state in which the FIN/ACK packet has been exchanged.

If an ACK packet is stored in a frame received by the relay unit 51, the monitoring unit 52 acquires a source port number and a destination port number from a TCP header of the ACK packet, and specifies identification information DA that matches the acquired set of the source port number and the destination port number from among pieces of identification information DA stored in the storage unit 55. Then, the monitoring unit 52 updates the state information corresponding to the specified identification information DA to state information indicating that transition has been made to the state in which the ACK packet for the FIN/ACK packet has been exchanged. In addition, the monitoring unit 52 acquires a reception time tea3 that is a reception time te, by the relay unit 51, of the frame in which the ACK packet is stored, and stores, in the storage unit 55, the acquired reception time tea3 in association with the specified identification information DA. The reception time tea3 corresponds to the time at which the state of the communication connection as the monitoring target has transitioned to the state in which the ACK packet for the FIN/ACK packet has been exchanged.

Based on a plurality of reception times ts stored in the storage unit 55 by the monitoring unit 52, the detection unit 53 calculates a cycle C1A that is a cycle C1 at which a TCP connection between the communication device 111A and the communication device 111B is established. More specifically, each time the state information in the storage unit 55 is updated by the monitoring unit 52 and a reception time tsa3 is stored in the storage unit 55 by the monitoring unit 52, the detection unit 53 calculates, as the cycle C1A, a difference between this reception time tsa3 and a reception time tsa3 immediately before the reception time tsa3. The detection unit 53 may calculate the cycle C1A based on the reception time tsa2 or the reception time tsa1 instead of the reception time tsa3. Alternatively, in the state where the TCP connection has been established, the detection unit 53 may calculate the cycle C1A based on the reception time, in the relay unit 51, of the frame in which the TCP packet with a PSH flag being set to ON is stored.

For example, the detection unit 53 compares the calculated cycle C1A with predetermined threshold values TcLA, TcHA. It is assumed that the threshold value TcLA is smaller than the threshold value TcHA. For example, the threshold values TcLA, TcHA are set in advance based on a result of monitoring a TCP connection established in the normal network 12 in which an unauthorized communication connection does not exist.

When the cycle C1A is equal to or larger than the threshold value TcLA and the cycle C1A is equal to or smaller than the threshold value TcHA, the detection unit 53 determines that an unauthorized communication connection does not exist in the network 12. On the other hand, when the cycle C1A is smaller than the threshold value TcLA or the cycle C1A is larger than the threshold value TcHA, the detection unit 53 determines that an unauthorized communication connection exists in the network 12.

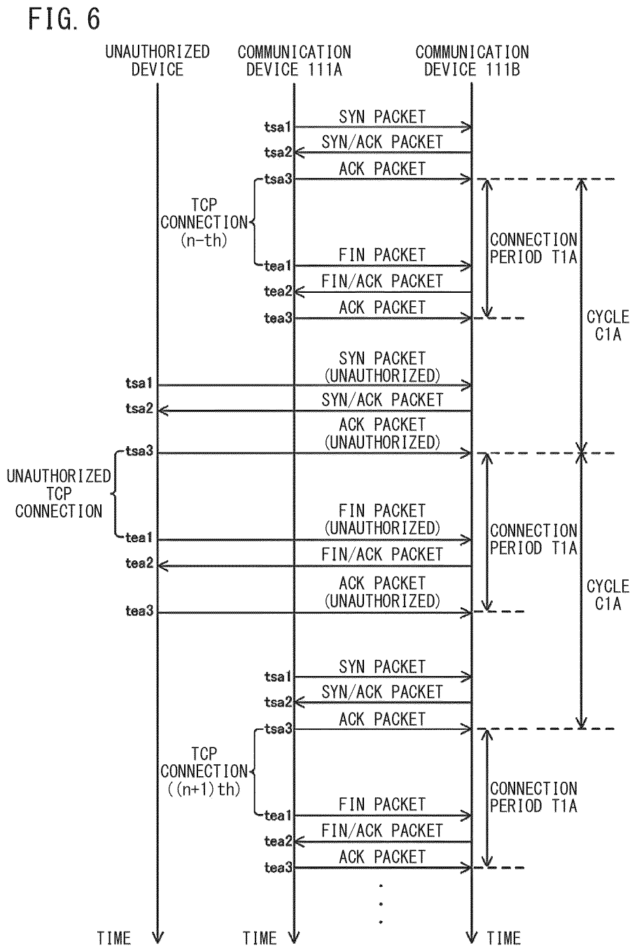

FIG. 6 shows an example of a communication connection operation of a monitoring target of the monitoring unit in the relay device according to the embodiment of the present disclosure. FIG. 6 shows a time chart of messages transmitted and received by the communication devices 111A, 111B being communication devices 111.

With reference to FIG. 6, for example, an unauthorized device that is an unauthorized communication device acquires a source port number and a destination port number from a TCP header in a frame that is addressed to the communication device 111B and is transmitted by the communication device 111A, masquerades as the communication device 111A, and transmits an SYN packet to the communication device 111B via the relay device 101. In addition, the unauthorized device masquerades as the communication device 111A and transmits, to the communication device 111B via the relay device 101, an ACK packet as a response to the SYN/ACK packet from the communication device 111B, thereby establishing an unauthorized TCP connection that is an unauthorized communication connection with the communication device 111B.

After the establishment of the TCP connection with the communication device 111B, the unauthorized device transmits an unauthorized message (not shown) to the communication device 111B via the relay device 101. Thereafter, the unauthorized device masquerades as the communication device 111A, and transmits an FIN packet to the communication device 111B via the relay device 101. In addition, the unauthorized device masquerades as the communication device 111A and transmits, to the communication device 111B via the relay device 101, an ACK packet as a response to the FIN/ACK packet from the communication device 111B, thereby ending the TCP connection with the communication device 111B.

For example, when an unauthorized TCP connection has been established in a period between the connection period T1A of the n-th TCP connection between the communication device 111A and the communication device 111B, and the connection period T1A of the (n+1)th TCP connection between the communication device 111A and the communication device 111B, the number of ACK packets, which are transmitted in response to the SYN/ACK packet to the communication device 111B, is increased as compared to the case where such an unauthorized TCP connection is not established.

In this case, since the cycle C1A that is a difference between the reception time tsa3 of an SYN packet transmitted from the unauthorized device and the reception time tsa3 of an SYN packet transmitted from the communication device 111A immediately before the SYN packet is smaller than the threshold value TcLA, the detection unit 53 determines that an unauthorized communication connection exists in the network 12. In addition, since the cycle C1A that is a difference between the reception time tsa3 of an SYN packet transmitted from the communication device 111A and the reception time tsa3 of an SYN packet transmitted from the unauthorized device immediately before the SYN packet is smaller than the threshold value TcLA, the detection unit 53 determines that an unauthorized communication connection exists in the network 12.

Instead of or in addition to the aforementioned specific example 1 of the detection process, the detection unit 53 may calculate dispersion of the cycle C1A, and detect the presence of an unauthorized communication connection in the network 12, based on a result of comparison between the calculated dispersion and a predetermined threshold value.

### Specific Example 2 of Detection Process

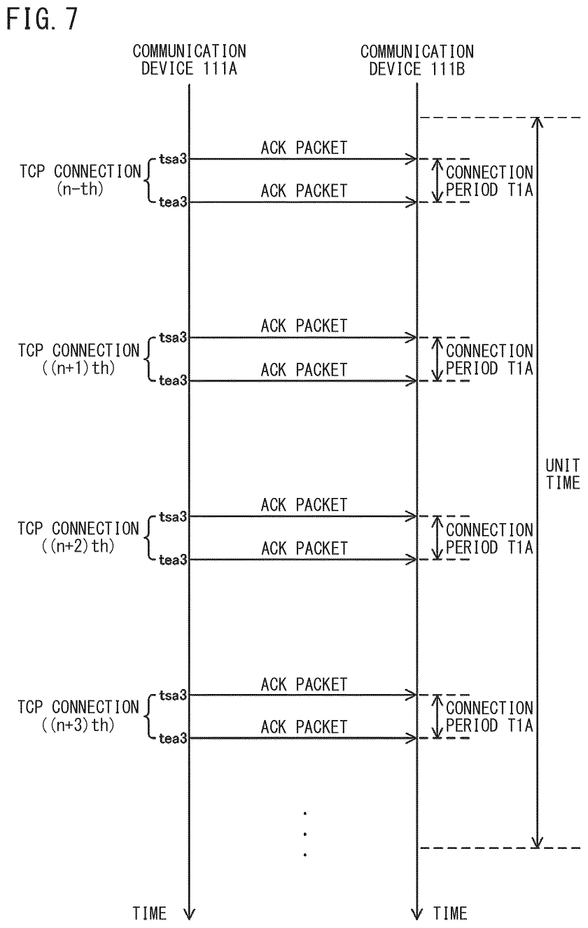

FIG. 7 shows an example of a communication connection operation of a monitoring target of the monitoring unit in the relay device according to the embodiment of the present disclosure. FIG. 7 shows a time chart of messages transmitted and received by the communication devices 111A, 111B being communication devices 111.

With reference to FIG. 7, based on a plurality of reception times tsa3 stored in the storage unit 55 by the monitoring unit 52, the detection unit 53 calculates a frequency F1A that is a frequency F1 at which a TCP connection between the communication device 111A and the communication device 111B is established. More specifically, for example, at a detection timing according to a predetermined cycle, the detection unit 53 calculates, as the frequency F1A, the number of times the relay unit 51 receives an ACK packet in response to an SYN/ACK packet during a unit time of a predetermined length. The detection unit 53 may calculate the frequency F1A, based on the reception time tsa1, the reception time tsa3, the reception time tea1, the reception time tea2, or the reception time tea3 instead of the reception time tsa3.

For example, the detection unit 53 compares the calculated frequency F1A with predetermined threshold values TfLA, TfHA. Here, it is assumed that the threshold value TfLA is smaller than the threshold value TfHA. For example, the threshold values TfLA, TfHA are set in advance based on a result of monitoring a TCP connection established in the normal network 12 in which an unauthorized communication connection does not exist.

When the frequency F1A is equal to or larger than the threshold value TfLA and the frequency F1A is equal to or smaller than the threshold value TfHA, the detection unit 53 determines that an unauthorized communication connection does not exist in the network 12 during a period from the previous detection timing to the current detection timing. On the other hand, when the frequency F1A is smaller than the threshold value TfLA or the frequency F1A is larger than the threshold value TfHA, the detection unit 53 determines that an unauthorized communication connection exists in the network 12 during the period from the previous detection timing to the current detection timing.

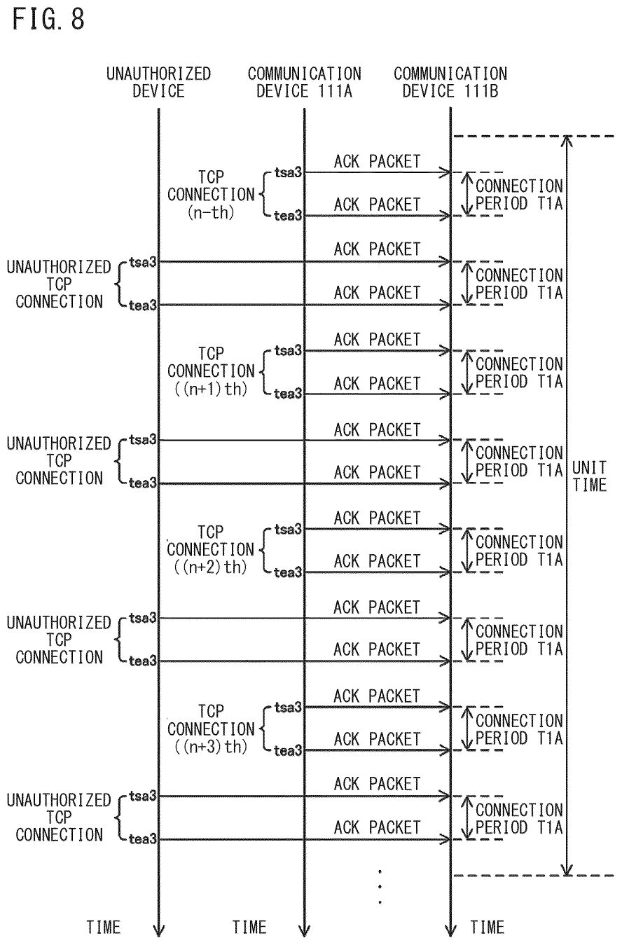

FIG. 8 shows an example of a communication connection operation of a monitoring target of the monitoring unit in the relay device according to the embodiment of the present disclosure. FIG. 8 shows a time chart of messages transmitted and received by the communication devices 111A, 111B being communication devices 111.

With reference to FIG. 8, when an unauthorized TCP connection between the unauthorized device and the communication device 111B has been repeatedly established, the number of ACK packets, which are transmitted in response to the SYN/ACK packets to the communication device 111B, is increased as compared to the case where such an unauthorized TCP connection is not established.

In this case, since the frequency F1A calculated at the detection timing is larger than the threshold value TfHA, the detection unit 53 determines that an unauthorized communication connection exists in the network 12 during the period from the previous detection timing to the current detection timing.

The detection unit 53 may determine that an unauthorized communication connection exists in the network 12 at a time point when the number of ACK packets, which have been transmitted in response to the SYN/ACK packets to the communication device 111B, exceeds the threshold value TfLA before the unit time elapses. Instead of calculating the frequency F1A at the detection timing according to the predetermined cycle, the detection unit 53 may calculate a frequency F1A in the most recent unit time of a predetermined length, each time the reception time tsa3 is stored in the storage unit 55 by the monitoring unit 52.

### Specific Example 3 of Detection Process

Referring back to FIG. 7, at a detection timing according to a predetermined cycle, the detection unit 53 calculates a ratio R1A that is a ratio R1 of the total sum of connection periods T1A to a unit time, based on the reception time tsa3 and the corresponding reception time tea3 stored in the storage unit 55 by the monitoring unit 52.

For example, the detection unit 53 compares the calculated ratio R1A with predetermined threshold values TrLA, TrHA. Here, it is assumed that the threshold value TrLA is smaller than the threshold value TrHA. For example, the threshold values TrLA, TrHA are set in advance based on a result of monitoring a TCP connection established in the normal network 12 in which an unauthorized communication connection does not exist.

When the ratio R1A is equal to or larger than the threshold value TrLA and the ratio R1A is equal to or smaller than the threshold value TrHA, the detection unit 53 determines that an unauthorized communication connection does not exist in the network 12 during the period from the previous detection timing to the current detection timing. On the other hand, when the ratio R1A is smaller than the threshold value TrLA or the ratio R1A is larger than the threshold value TrHA, the detection unit 53 determines that an unauthorized communication connection exists in the network 12 during the period from the previous detection timing to the current detection timing.

Referring back to FIG. 8, when an unauthorized TCP connection between the unauthorized device and the communication device 111B has been repeatedly established, the total sum of connection periods T1A in the unit time increases as compared to the case where such an unauthorized TCP connection is not established.

In this case, since the ratio R1A calculated at the detection timing is larger than the threshold value TrHA, the detection unit 53 determines that an unauthorized communication connection exists in the network 12 during the period from the previous detection timing to the current detection timing.

The detection unit 53 may determine that an unauthorized communication connection exists in the network 12 at a time point when the total value of connection periods T1A exceeds the predetermined value before the unit time elapses. Instead of calculating the ratio R1A at the detection timing according to the predetermined cycle, the detection unit 53 may calculate a ratio R1A in the most recent unit time of a predetermined length, each time the reception time tsa3 is stored in the storage unit 55 by the monitoring unit 52.

In addition to the aforementioned specific example 3 of the detection process, each time the connection period T1A is calculated based on the reception time tsa3 and the corresponding reception time tea3 stored in the storage unit 55 by the monitoring unit 52, the detection unit 53 may determine whether or not an unauthorized communication connection exists in the network 12, based on the result of comparison between the calculated connection period T1A and the predetermined threshold value. Here, for example, the connection period T1A of the unauthorized TCP connection is a predetermined value or more larger than the normal value, or a predetermined value or more smaller than the normal value. Therefore, the detection unit 53 can determine whether or not an unauthorized communication connection exists in the network 12, based on a result of comparison between the connection period T1A and the predetermined threshold value.

The monitoring unit 52 is not limited to the configuration of monitoring a communication connection that is established and ended according to the connection type protocol, and may be configured to monitor a communication connection that is established and ended according to another protocol.

### Specific Example 4 of Detection Process

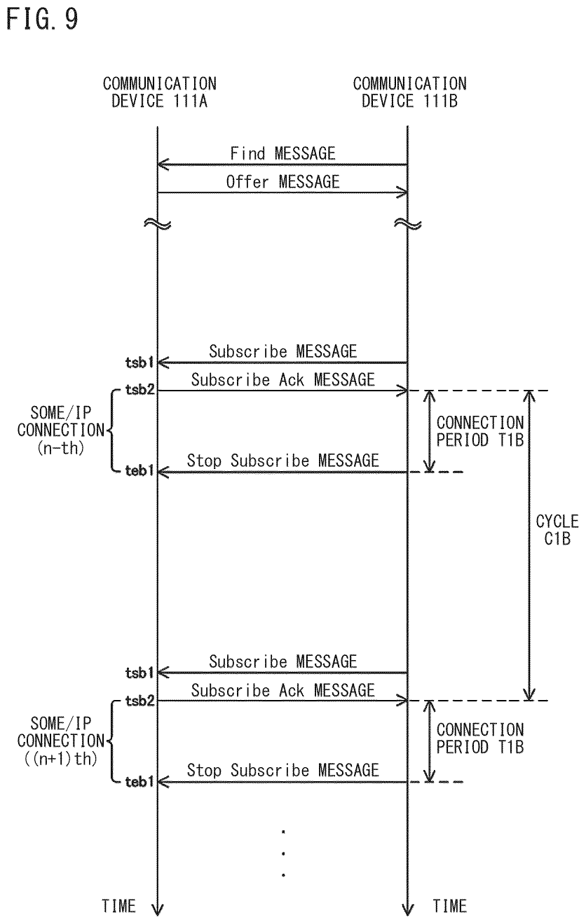

FIG. 9 shows an example of a communication connection operation of a monitoring target of the monitoring unit in the relay device according to the embodiment of the present disclosure. FIG. 9 shows a time chart of messages transmitted and received by the communication devices 111A, 111B being communication devices 111.

With reference to FIG. 9, in the network 12, messages are transmitted and received according to SOME/IP that is an application layer protocol in the Ethernet protocol group. For example, the communication device 111 can transmit and receive messages conforming to SOME/IP instead of or in parallel with transmission and reception of messages conforming to TCP/IP.

The communication device 111 establishes a communication connection for providing a periodic service by using the Publish/Subscribe function of SOME/IP. Hereinafter, the communication connection for providing a periodic service in SOME/IP is also referred to as “SOME/IP connection”.

More specifically, when the communication device 111B receives a service, the communication device 111B, as a client, broadcasts a Find message including a service ID corresponding to the service.

Of a plurality of communication devices 111 having received the Find message, the communication device 111A having an application capable of providing a service corresponding to the service ID included in the Find message transmits, as a server, an Offer message indicating the start of provision of the service, to the communication device 111B via the relay device 101. In a SOME/IP header of the Offer message, for example, a server ID as an ID of the communication device 111A is stored.

Thereafter, if the communication device 111B requests the communication device 111A to periodically provide the service, the communication device 111B, by using the server ID acquired from the Offer message, transmits a Subscribe message that is a message including the server ID and the service ID to the communication device 111A via the relay device 101.

The communication device 111A receives the Subscribe message, and checks the service ID included in the Subscribe message. If the service ID matches the service ID corresponding to a service that can be provided, the communication device 111A transmits a Subscribe Ack message that is a message indicating approval of provision of the service, to the communication device 111B via the relay device 101. Thus, the n-th SOME/IP connection between the communication device 111A and the communication device 111B is established. The Subscribe message and the Subscribe Ack message are examples of the stateful message MS.

When the communication device 111B stops receiving the service, i.e., ends the SOME/IP connection, the communication device 111B transmits a Stop Subscribe message to the communication device 111A via the relay device 101. The Stop Subscribe message is an example of the stateful message ME.

During the connection period TIB in which the SOME/IP connection with the communication device 111B is established, the communication device 111A periodically transmits, as a service, a Notification message that is a message conforming to SOME/IP to the communication device 111B via the relay device 101.

Thereafter, establishment and ending of the SOME/IP connection between the communication device 111A and the communication device 111B are repeated in a similar manner using the Subscribe message, the Subscribe Ack message, and the Stop Subscribe message.

The communication device 111A may be configured to end the SOME/IP connection instead of the communication device 111B. Specifically, the communication device 111A transmits a Stop Offer message to the communication device 111B via the relay device 101. Thus, the SOME/IP connection between the communication device 111A and the communication device 111B is ended. In this case, establishment and ending of the SOME/IP connection between the communication device 111A and the communication device 111B using the Find message, the Offer message, the Subscribe message, the Subscribe Ack message, and the Stop Offer message, are repeated.

The monitoring unit 52 monitors the SOME/IP connection as an example of a communication connection established in the network 12. As described above, the SOME/IP connection is established by using the Subscribe Ack message, and is ended by using the Stop Offer message or the Stop Subscribe message. For example, the monitoring unit 52 monitors, for each service ID, the SOME/IP connection established in the network 12.

More specifically, if a Subscribe message is stored in a frame received by the relay unit 51, the monitoring unit 52 determines that a SOME/IP connection is established between the communication device 111 as the source of the frame and the communication device 111 as the destination of the frame.

Then, the monitoring unit 52 acquires a service ID from the SOME/IP header of the Subscribe message, and stores the acquired service ID in the storage unit 55 as identification information DB indicating the communication connection as a monitoring target. In addition, the monitoring unit 52 generates state information indicating that the state of the communication connection as the monitoring target has transitioned to the state in which the Subscribe message has been exchanged, and stores the generated state information in the storage unit 55 in association with the identification information DB. Furthermore, the monitoring unit 52 acquires a reception time tsb1 that is a reception time ts, by the relay unit 51, of the frame in which the Subscribe message is stored, and stores, in the storage unit 55, the acquired reception time tsb1 in association with the identification information DB. The reception time tsb1 corresponds to the time at which the state of the communication connection as the monitoring target has transitioned to the state in which the Subscribe message has been exchanged.

If a Subscribe Ack message is stored in a frame received by the relay unit 51, the monitoring unit 52 acquires a service ID from the SOME/IP header of the Subscribe Ack message, and specifies identification information DB that matches the acquired service ID from among pieces of identification information DB stored in the storage unit 55. Then, the monitoring unit 52 updates the state information corresponding to the specified identification information DB to state information indicating that transition has been made to the state in which the Subscribe Ack message has been exchanged. In addition, the monitoring unit 52 acquires a reception time tsb2 that is a reception time ts, by the relay unit 51, of the frame in which the Subscribe Ack message is stored, and stores the acquired reception time tsb2 in the storage unit 55 in association with the specified identification information DB. The reception time tsb2 corresponds to the time at which the state of the communication connection as the monitoring target has transitioned to the state in which the Subscribe Ack message has been exchanged.

If a Stop Subscribe message is stored in a frame received by the relay unit 51, the monitoring unit 52 acquires a service ID from the SOME/IP header of the Stop Subscribe message, and specifies identification information DB that matches the acquired service ID from among pieces of identification information DB stored in the storage unit 55. Then, the monitoring unit 52 updates the state information corresponding to the specified identification information DB to state information indicating that transition has been made to the state in which the Stop Subscribe message has been exchanged. In addition, the monitoring unit 52 acquires a reception time teb1 that is a reception time te of the frame in which the Stop Subscribe message is stored, and stores the acquired reception time teb1 in the storage unit 55 in association with the specified identification information DB. The reception time teb1 corresponds to the time at which the state of the communication connection as the monitoring target has transitioned to the state in which the Stop Subscribe message has been exchanged.

Based on a plurality of reception times ts stored in the storage unit 55 by the monitoring unit 52, the detection unit 53 calculates a cycle C1B that is a cycle C1 at which a SOME/IP connection between the communication device 111A and the communication device 111B is established. More specifically, each time the state information in the storage unit 55 is updated by the monitoring unit 52 and a reception time tsb2 is stored in the storage unit 55 by the monitoring unit 52, the detection unit 53 calculates, as the cycle C1B, a difference between this reception time tsb2 and a reception time tsb2 immediately before the reception time tsb2. The detection unit 53 may calculate the cycle C1B based on the reception time tsb1 instead of the reception time tsb2. Alternatively, in the state where the SOME/IP connection has been established, the detection unit 53 may calculate the cycle C1B based on the reception time, in the relay unit 51, of the frame in which the Notification message is stored.

For example, the detection unit 53 compares the calculated cycle C1B with predetermined threshold values TeLB, TcHB. It is assumed that the threshold value TeLB is smaller than the threshold value TcHB. For example, the threshold values TcLB, TcHB are set in advance based on the result of monitoring a SOME/IP connection established in the normal network 12 in which an unauthorized communication connection does not exist.

When the cycle C1B is equal to or larger than the threshold value TcLB and the cycle C1B is equal to or smaller than the threshold value TcHB, the detection unit 53 determines that an unauthorized communication connection does not exist in the network 12. On the other hand, when the cycle C1B is smaller than the threshold value TeLB or the cycle C1B is larger than the threshold value TcHB, the detection unit 53 determines that an unauthorized communication connection exists in the network 12.

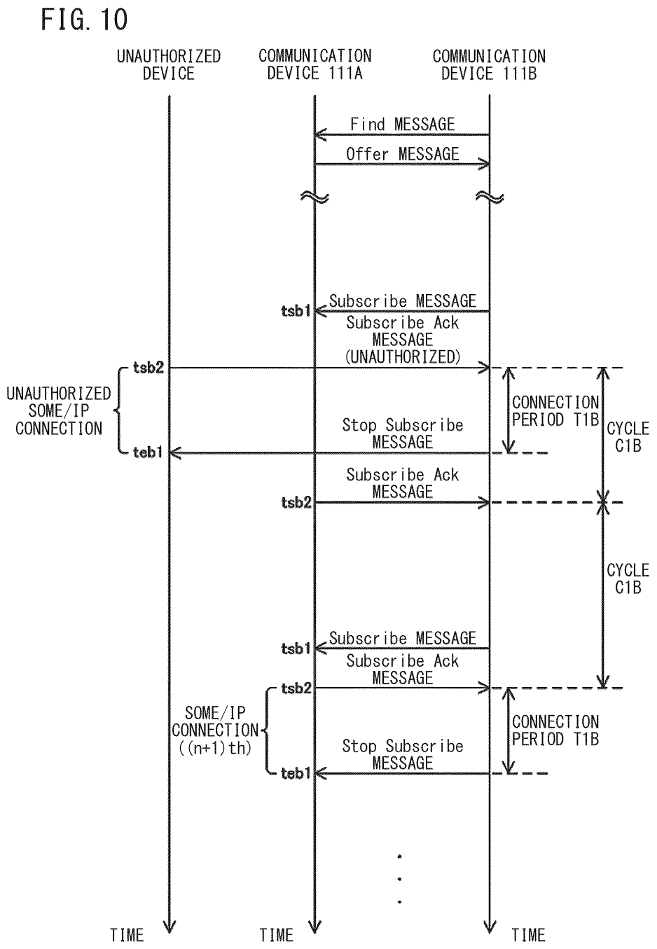

FIG. 10 shows an example of a communication connection operation of a monitoring target of the monitoring unit in the relay device according to the embodiment of the present disclosure. FIG. 10 shows a time chart of messages transmitted and received by the communication devices 111A, 111B being communication devices 111.

With reference to FIG. 10, for example, an unauthorized device that is an unauthorized communication device acquires a service ID from a SOME/IP header in a frame that is transmitted from the communication device 111A and addressed to the communication device 111B. After a Subscribe message has been transmitted by the communication device 111B, the unauthorized device masquerades as the communication device 111A, and transmits a Subscribe Ack message to the communication device 111B via the relay device 101, thereby establishing an unauthorized SOME/IP connection with the communication device 111B.

After the establishment of the SOME/IP connection with the communication device 111B, the unauthorized device transmits an unauthorized message, i.e., an unauthorized Notification message, to the communication device 111B via the relay device 101. Thereafter, the communication device 111B transmits a Stop Subscribe message to the unauthorized device via the relay device 101, thereby ending the SOME/IP connection with the unauthorized device.

The communication device 111A as a normal server transmits a Subscribe Ack message to the communication device 111B via the relay device 101, as a response to the Subscribe message transmitted by the communication device 111B. For example, after the SOME/IP connection with the unauthorized device has been established by transmitting and receiving a Subscribe message and a Subscribe Ack message, if the communication device 111B receives a Subscribe Ack message in response to the Subscribe message from the communication device 111A, the communication device 111B ignores the Subscribe Ack message received from the communication device 111A, and does not establish a SOME/IP connection with the communication device 111A.

For example, there is a case where the unauthorized device masquerades as the communication device 111B as a client, and transmits a Subscribe message to the communication device 111A via the relay device 101. In this case, an unauthorized SOME/IP connection between the unauthorized device and the communication device 111A is established when the communication device 111A transmits a Subscribe Ack message to the unauthorized device via the relay device 101. In this case, after the establishment of the SOME/IP connection with the unauthorized device, the communication device 111A transmits a Notification message to the unauthorized device via the relay device 101.

When the unauthorized SOME/IP connection between the unauthorized device and the communication device 111 has been established, the number of Subscribe Ack messages transmitted to the communication device 111B or the number of Subscribe Ack messages transmitted by the communication device 111A increases as compared to the case where such an unauthorized SOME/IP connection is not established.

In this case, since the cycle C1B, which is a difference between the reception time tsb2 of a Subscribe Ack message transmitted from the communication device 111A and the reception time tsb2 of a Subscribe Ack message transmitted from the unauthorized device immediately before the Subscribe Ack message, is smaller than the threshold value TcLB, the detection unit 53 determines that an unauthorized communication connection exists in the network 12.

Instead of or in addition to the aforementioned specific example 4 of the detection process, the detection unit 53 may calculate dispersion of the cycle C1B, and determine whether or not an unauthorized communication connection exists in the network 12, based on a result of comparison between the calculated dispersion and a predetermined threshold value.

Instead of or in addition to the aforementioned specific example 4 of the detection process, the detection unit 53 may calculate a frequency F1B that is a frequency F1 at which a SOME/IP connection between the communication device 111A and the communication device 111B is established, based on a plurality of reception times tsb2 stored in the storage unit 55 by the monitoring unit 52, and may detect the presence of an unauthorized communication connection in the network 12, based on a result of comparison between the calculated frequency F1B and a predetermined threshold value.

Instead of or in addition to the aforementioned specific example 4 of the detection process, the detection unit 53 may calculate a ratio RIB that is a ratio R1 of a connection period TIB to a unit time, based on the reception time tsb2 and the corresponding reception time teb1 stored in the storage unit 55 by the monitoring unit 52, and may detect the presence of an unauthorized communication connection in the network 12, based on a result of comparison between the calculated ratio RIB and a predetermined threshold value.

In addition to the aforementioned specific example 4 of the detection process, the detection unit 53 may detect the presence of an unauthorized communication connection in the network 12, based on transmission timings of a Request message and a Response message conforming to SOME/IP in the network 12.

More specifically, the communication device 111B transmits a Request message including a server ID and a service ID to the communication device 111A via the relay device 101. As a response to the Request message, the communication device 111A transmits a Response message including the server ID and the service ID to the communication device 111B via the relay device 101.

The monitoring unit 52 in the relay device 101 acquires the reception time, by the relay unit 51, of a frame in which the Request message is stored and the reception time, by the relay unit 51, of a frame in which the Response message is stored, and stores the reception times in the storage unit 55. The detection unit 53 calculates a difference D between the reception time of the frame in which the Request message is stored and the reception time of the frame in which the Response message is stored, which are stored in the storage unit 55, and detects an unauthorized communication connection in the network 12, based on a result of comparison between the calculated difference D and a predetermined threshold value. Here, for example, if the unauthorized device, instead of the communication device 111A, transmits the Response message to the communication device 111B via the relay device 101, the difference D calculated by the detection unit 53 is a predetermined value or more larger than a normal value, or is a predetermined value or more smaller than the normal value. Therefore, the detection unit 53 can determine whether or not an unauthorized communication connection exists in the network 12, based on a result of comparison between the difference D and a predetermined threshold value.

### Specific Example 5 of Detection Process

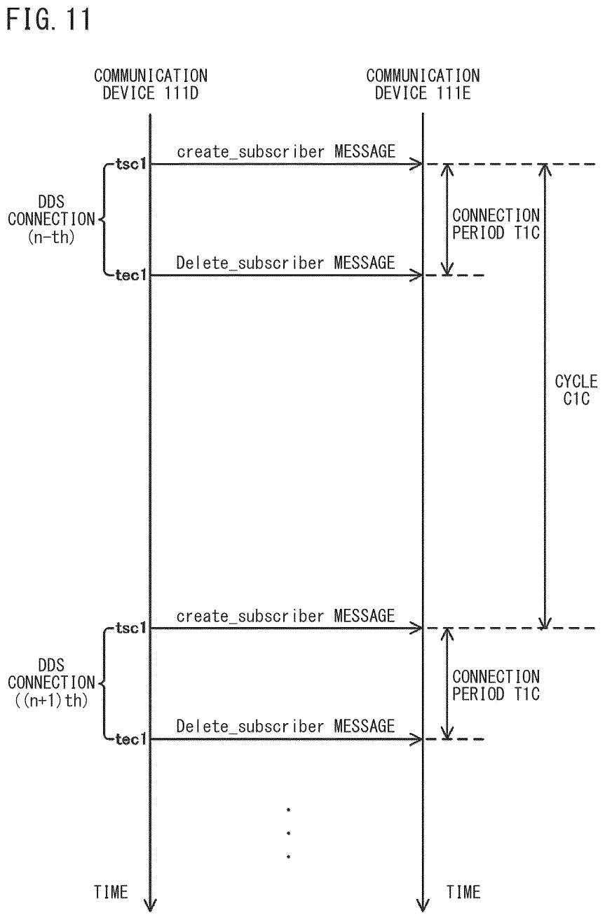

FIG. 11 shows an example of a communication connection operation of a monitoring target of the monitoring unit in the relay device according to the embodiment of the present disclosure. FIG. 11 shows a time chart of messages transmitted and received by the communication devices 111D, 111E being communication devices 111.

With reference to FIG. 11, in the network 12, messages are transmitted and received according to a DDS (Data Distribution Service). A communication device 111 establishes a communication connection for acquiring data from a cloud server or another communication device 111 that functions as a DDS domain. Hereinafter, the communication connection for acquiring data in the DDS is also referred to as “DDS connection”.

More specifically, the communication device 111E periodically or non-periodically receives data from a communication device 111 that is other than the communication devices 111D, 111E and functions as a DDS domain, and stores the received data.

When the communication device 111D acquires, from the communication device 111E, data that is related to a certain topic and is generated using an application corresponding to the topic, the communication device 111D generates a create_subscriber message including a topic ID corresponding to the topic, and transmits the generated create_subscriber message to the communication device 111E via the relay device 101. Thus, the n-th DDS connection between the communication device 111D and the communication device 111E is established. The create_subscriber message is an example of the stateful message MS.

When the communication device 111D ends acquisition of data from the communication device 111E, i.e., ends the DDS connection, the communication device 111D transmits a Delete_subscriber message to the communication device 111E via the relay device 101. Thus, the DDS connection between the communication device 111D and the communication device 111E is ended. The Delete_subscriber message is an example of the stateful message ME.

In a connection period T1C during which the DDS connection with the communication device 111D is established, the communication device 111E adds data, which is indicated by the topic ID included in the create_subscriber message, into an on_data_available message that is a message conforming to the DDS, and transmits the message to the communication device 111D via the relay device 101.

Thereafter, establishment and ending of the DDS connection between the communication device 111D and the communication device 111E are repeated in a similar manner.

The monitoring unit 52 monitors the DDS connection as an example of a communication connection established in the network 12. As described above, the DDS connection is established using the create_subscriber message, and is ended using the Delete_subscriber message. For example, the monitoring unit 52 monitors, for each topic ID, the DDS connection established in the network 12.

More specifically, if a create_subscriber message is stored in a frame received by the relay unit 51, the monitoring unit 52 determines that a DDS connection between a communication device 111 as a source of the frame and a communication device 111 as a destination of the frame is established.

Then, the monitoring unit 52 acquires a topic ID from the header of the create_subscriber message, and stores, in the storage unit 55, the acquired topic ID as identification information DC indicating the communication connection as a monitoring target. In addition, the monitoring unit 52 generates state information indicating that the state of the communication connection as the monitoring target has transitioned to the state in which the create_subscriber message has been exchanged, and stores the generated state information in the storage unit 55 in association with the identification information DC. In addition, the monitoring unit 52 acquires a reception time tsc1 that is a reception time ts, by the relay unit 51, of the frame in which the create_subscriber message is stored, and stores the acquired reception time tsc1 in the storage unit 55 in association with the identification information DC. The reception time tsc1 corresponds to the time at which the state of the communication connection as the monitoring target has transitioned to the state in which the create_subscriber message has been exchanged.

If a Delete_subscriber message is stored in a frame received by the relay unit 51, the monitoring unit 52 acquires a topic ID from the header of the Delete_subscriber message, and specifies identification information DC that matches the acquired topic ID from among pieces of identification information DC stored in the storage unit 55. Then, the monitoring unit 52 updates the state information corresponding to the specified identification information DC to state information indicating that transmission has been made to the state in which the Delete_subscriber message has been exchanged. In addition, the monitoring unit 52 acquires a reception time tec1 that is a reception time te of the frame in which the Delete_subscriber message is stored, and stores the acquired reception time tec1 in the storage unit 55 in association with the specified identification information DC. The reception time tec1 corresponds to the time at which the state of the communication connection as the monitoring target has transitioned to the state in which the Delete_subscriber message has been exchanged.

At a detection timing according to a predetermined cycle, the detection unit 53 calculates a ratio R1C that is a ratio R1 of a connection period T1C to a unit time, based on the reception time tsc1 and the corresponding reception time tec1 stored in the storage unit 55 by the monitoring unit 52.

For example, the detection unit 53 compares the calculated ratio R1C with predetermined threshold values TrLC, TrHC. It is assumed that the threshold value TrLC is smaller than the threshold value TrHC. For example, the threshold values TrLC, TrHC are set in advance based on the result of monitoring a DDS connection established in the normal network 12 in which an unauthorized communication connection does not exist.

When the ratio R1C is equal to or larger than the threshold value TrLC and the ratio R1C is equal to or smaller than the threshold value TrHC, the detection unit 53 determines that an unauthorized communication connection does not exist in the network 12 during the period from the previous detection timing to the current detection timing. On the other hand, when the ratio R1C is smaller than the threshold value TrLC or the ratio R1C is larger than the threshold value TrHC, the detection unit 53 determines that an unauthorized communication connection exists in the network 12 during the period from the previous detection timing to the current detection timing.

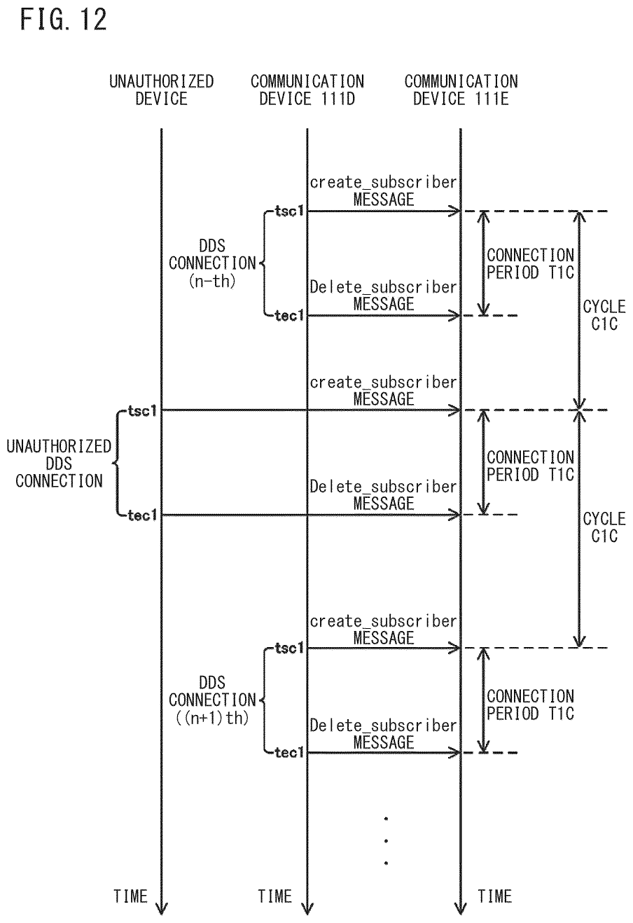

FIG. 12 shows an example of a communication connection operation of a monitoring target of the monitoring unit in the relay device according to the embodiment of the present disclosure. FIG. 12 shows a time chart of messages transmitted and received by the communication devices 111D, 111E being communication devices 111.

With reference to FIG. 12, for example, an unauthorized device acquires a topic ID from a header in a frame that is transmitted from the communication device 111D and addressed to the communication device 111E, masquerades as the communication device 111D, and transmits a create_subscriber message to the communication device 111E via the relay device 101, thereby establishing an unauthorized DDS connection with the communication device 111E.

After the establishment of the DDS connection with the communication device 111E, the unauthorized device receives an on_data_available message from the communication device 111E, and acquires data from the received on_data_available message. Thereafter, the unauthorized device masquerades as the communication device 111D, and transmits a Delete_subscriber message to the communication device 111E via the relay device 101, thereby ending the DDS connection with the communication device 111E.

For example, when an unauthorized DDS connection between the unauthorized device and the communication device 111E has been repeatedly established, the total sum of connection periods T1C in the unit time increases as compared to the case where such an unauthorized DDS connection is not established.

In this case, since the ratio R1C calculated at the detection timing is larger than the threshold value TrHC, the detection unit 53 determines that an unauthorized communication connection exists in the network 12 during the period from the previous detection timing to the current detection timing.

The detection unit 53 may determine that an unauthorized communication connection exists in the network 12 at a time point when the total value of connection periods T1C exceeds a predetermined value before the unit time elapses. Instead of calculating the ratio R1C at the detection timing according to the predetermined cycle, the detection unit 53 may calculate a ratio R1C in the most recent unit time of a predetermined length, each time the state information in the storage unit 55 is updated by the monitoring unit 52 and the reception time tsc1 is stored in the storage unit 55 by the monitoring unit 52.

Instead of or in addition to the aforementioned specific example 5 of the detection process, the detection unit 53 may calculate a cycle CIC that is a cycle C1 at which a DDS connection between the communication device 111D and the communication device 111E is established, based on the reception time tsc1 stored in the storage unit 55 by the monitoring unit 52, and may detect the presence of an unauthorized communication connection in the network 12, based on a result of comparison between the calculated cycle CIC and a predetermined threshold value.

Instead of or in addition to the aforementioned specific example 5 of the detection process, the detection unit 53 may calculate a frequency FIC that is a frequency F1 at which a DDS connection between the communication device 111D and the communication device 111E is established, based on a plurality of reception times tsc1 stored in the storage unit 55 by the monitoring unit 52, and may detect the presence of an unauthorized communication connection in the network 12, based on a result of comparison between the calculated frequency FIC and a predetermined threshold value.

The detection unit 53 may not necessarily perform some of the aforementioned specific examples 1 to 5 of the detection process.

### Operation Flow

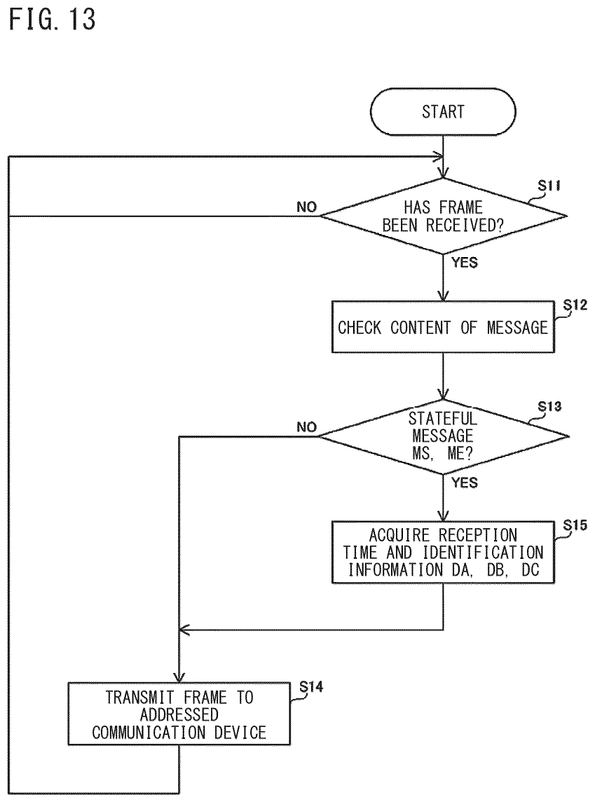

FIG. 13 is a flowchart showing an example of an operation procedure when the relay device according to the embodiment of the present disclosure monitors a communication connection.

With reference to FIG. 13, the relay device 101 waits for arrival of a frame from a communication device 111 (NO in step S11). Upon receiving a frame (YES in step S11), the relay device 101 checks the content of a message stored in the frame by referring to header information of the received frame (step S12).

Next, when the message stored in the received frame is neither a stateful message MS such as an SYN packet and an SYN/ACK packet conforming to TCP/IP, a Subscribe message and a Subscribe Ack message conforming to SOME/IP, and a create_subscriber message conforming to DDS, nor a stateful message ME such as an FIN packet and a FIN/ACK packet conforming to TCP/IP, a Stop Offer message and a Stop Subscribe message conforming to SOME/IP, and a Delete_subscriber message conforming to DDS (NO in step S13), the relay device 101 transmits the received frame to the addressed communication device 111 (step S14).

On the other hand, when the message included in the received frame is a stateful message MS or a stateful message ME (YES in step S13), the relay device 101 determines that the state of a communication connection between a communication device 111 as a source of the frame and a communication device 111 as a destination of the frame has transitioned, and acquires identification information DA, DB, DC indicating the communication connection as a monitoring target, and the reception time of the frame. The relay device 101 stores the reception time of the frame in the storage unit 55 in association with the identification information DA, DB, DC. In addition, the relay device 101 generates or updates the state information indicating the transition of the state of the communication connection as the monitoring target (Step S15).

Next, the relay device 101 transmits the frame to the communication device 111 that is a destination (step S14).

Next, the relay device 101 waits for arrival of a new frame from a communication device 111 (NO in step S11).

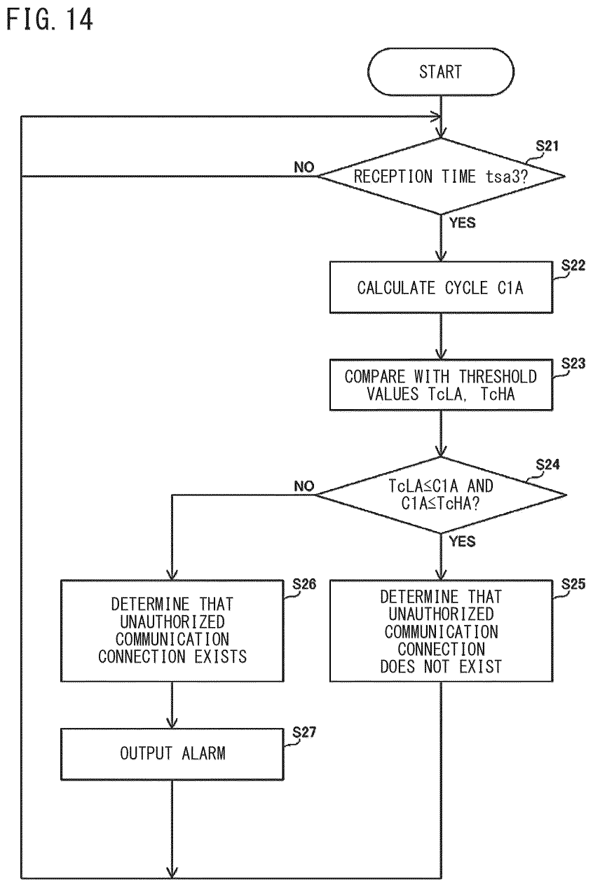

FIG. 14 is a flowchart showing an example of an operation procedure when the relay device according to the embodiment of the present disclosure performs a detection process. FIG. 14 is a flowchart showing the aforementioned specific example 1 of the detection process.

With reference to FIG. 14, the detection unit 53 in the relay device 101 waits for the monitoring unit 52 to update the state information in the storage unit 55 and store the reception time tsa3 in the storage unit 55 (NO in step S21). When the state information has been updated and the reception time tsa3 has been stored in the storage unit 55 (YES in step S21), the detection unit 53 calculates, as a cycle C1A, a difference between the reception time tsa3 and the immediately preceding reception time tsa3 corresponding to the same identification information DA (step S22).

Next, the detection unit 53 compares the calculated cycle C1A with predetermined threshold values TcLA, TcHA (step S23).

Next, when the cycle C1A is equal to or larger than the threshold value TcLA and the cycle C1A is equal to or smaller than the threshold value TcHA (YES in step S24), the detection unit 53 determines that an unauthorized communication connection does not exist in the network 12 (step S25).

Next, the detection unit 53 waits for the monitoring unit 52 to update the state information in the storage unit 55 and store a new reception time tsa3 in the storage unit 55 (NO in step S21).

On the other hand, when the cycle C1A is smaller than the threshold value TcLA or the cycle C1A is larger than the threshold value TcHA (NO in step S24), the detection unit 53 determines that an unauthorized communication connection exists in the network 12 (step S26).

Next, the output unit 54 outputs an alarm indicating that an unauthorized communication connection is detected, to the user's terminal or the like (step S27).

Next, the detection unit 53 waits for the monitoring unit 52 to update the state information in the storage unit 55 and store a new reception time tsa3 in the storage unit 55 (NO in step S21).

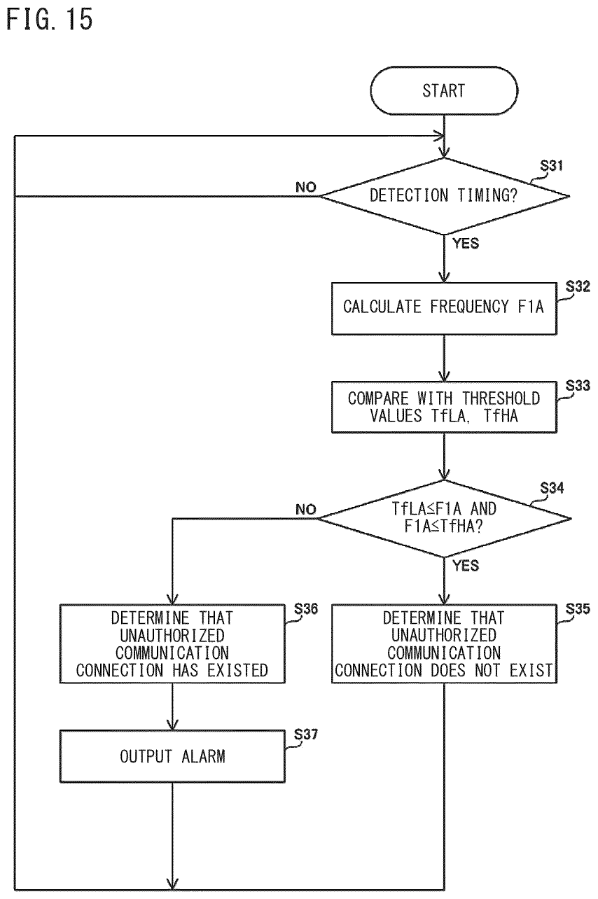

FIG. 15 is a flowchart showing an example of an operation procedure when the relay device according to the embodiment of the present disclosure performs a detection process. FIG. 15 is a flowchart showing the aforementioned specific example 2 of the detection process.

With reference to FIG. 15, the detection unit 53 in the relay device 101 waits for arrival of a detection timing according to a predetermined cycle (NO in step S31). When a detection timing has arrived (YES in step S31), based on a plurality of reception times tsa3 stored in the storage unit 55, the detection unit 53 calculates, as a frequency F1A, the number of times the relay unit 51 receives an ACK packet in response to an SYN/ACK packet during a unit time of a predetermined length (step S32).

Next, the detection unit 53 compares the calculated frequency F1A with predetermined threshold values TfLA, TfHA (step S33).

Next, when the frequency F1A is equal to or larger than the threshold value TfLA and the frequency F1A is equal to or smaller than the threshold value THA (YES in step S34), the detection unit 53 determines that an unauthorized communication connection does not exist in the network 12 during the period from the previous detection timing to the current detection timing (step S35).

Next, the detection unit 53 waits for arrival of a new detection timing (NO in step S31).

On the other hand, when the frequency F1A is smaller than the threshold value TfLA or the frequency F1A is larger than the threshold value TfHA (NO in step S34), the detection unit 53 determines that an unauthorized communication connection exists in the network 12 during the period from the previous detection timing to the current detection timing (step S36).

Next, the output unit 54 outputs an alarm indicating that an unauthorized communication connection is detected, to the user's terminal or the like (step S37).

Next, the detection unit 53 waits for arrival of a new detection timing (NO in step S31).

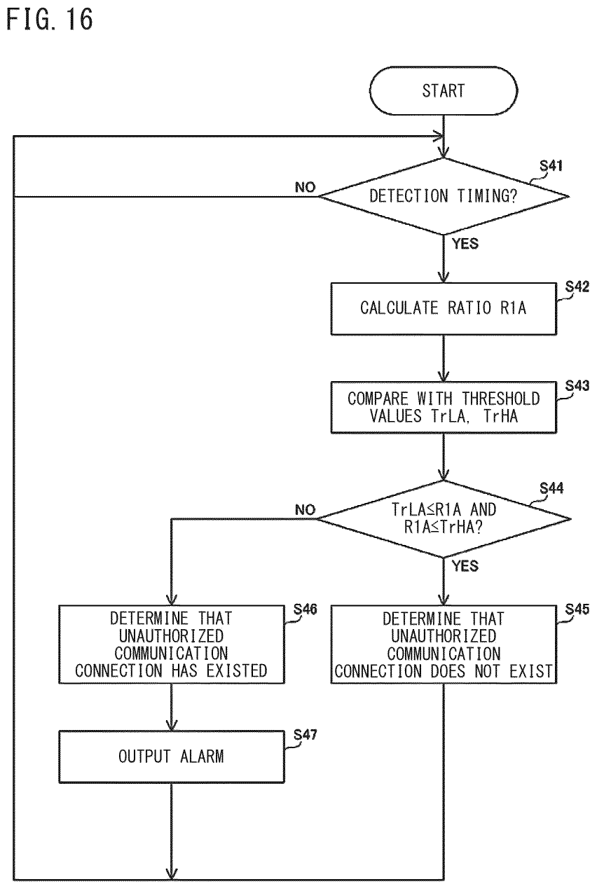

FIG. 16 is a flowchart showing an example of an operation procedure when the relay device according to the embodiment of the present disclosure performs a detection process. FIG. 16 is a flowchart showing the aforementioned specific example 3 of the detection process.

With reference to FIG. 16, the detection unit 53 in the relay device 101 waits for arrival of a detection timing according to a predetermined cycle (NO in step S41). When a detection timing has arrived (YES in step S41), the detection unit 53 calculates a ratio R1A of a connection period T1A to a unit time, based on the reception time tsa3 and the corresponding reception time tea3 stored in the storage unit 55 (step S42).

Next, the detection unit 53 compares the calculated ratio R1A with predetermined threshold values TrLA, TrHA (step S43).

Next, when the ratio R1A is equal to or larger than the threshold value TrLA and the ratio R1A is equal to or smaller than the threshold value TrHA (YES in step S44), the detection unit 53 determines that an unauthorized communication connection does not exist in the network 12 during the period from the previous detection timing to the current detection timing (step S45).

Next, the detection unit 53 waits for arrival of a new detection timing (NO in step S41).

On the other hand, when the ratio R1A is smaller than the threshold value TrLA or the ratio R1A is larger than the threshold value TrHA (NO in step S44), the detection unit 53 determines that an unauthorized communication connection exists in the network 12 during the period from the previous detection timing to the current detection timing (step S46).

Next, the output unit 54 outputs an alarm indicating that an unauthorized communication connection is detected, to the user's terminal or the like (step 47).

Next, the detection unit 53 waits for arrival of a new detection timing (NO in step S41).

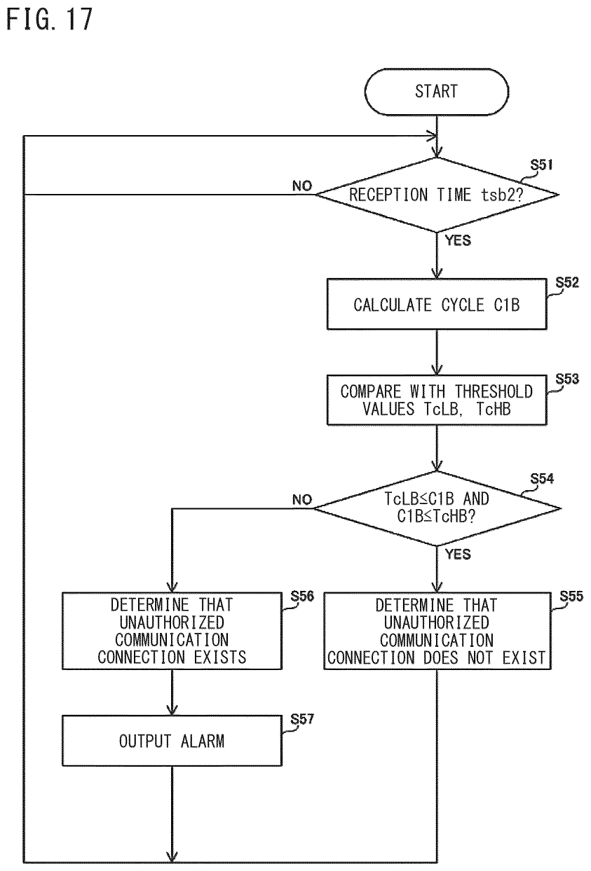

FIG. 17 is a flowchart showing an example of an operation procedure when the relay device according to the embodiment of the present disclosure performs a detection process. FIG. 17 is a flowchart showing the aforementioned specific example 4 of the detection process.

With reference to FIG. 17, the detection unit 53 in the relay device 101 waits for the monitoring unit 52 to update the state information in the storage unit 55 and store the reception time tsb2 in the storage unit 55 (NO in step S51). When the state information has been updated and the reception time tsb2 has been stored in the storage unit 55 (YES in step S51), the detection unit 53 calculates, as a cycle C1B, a difference between the reception time tsb2 and the immediately preceding reception time tsb2 corresponding to the same identification information DB (step S52).

Next, the detection unit 53 compares the calculated cycle C1B with predetermined threshold values TcLB, TcHB (step S53).

Next, when the cycle C1B is equal to or larger than the threshold value TeLB and the cycle C1B is equal to or smaller than the threshold value TcHB (YES in step S54), the detection unit 53 determines that an unauthorized communication connection does not exist in the network 12 (step S55).

Next, the detection unit 53 waits for the monitoring unit 52 to update the state information in the storage unit 55 and store a new reception time tsb2 in the storage unit 55 (NO in step S51).

On the other hand, when the cycle C1B is smaller than the threshold value TcLB or the cycle C1B is larger than the threshold value TcHB (NO in step S54), the detection unit 53 determines that an unauthorized communication connection exists in the network 12 (step S56).

Next, the output unit 54 outputs an alarm indicating that an unauthorized communication connection is detected, to the user's terminal or the like (step S57).

Next, the detection unit 53 waits for the monitoring unit 52 to update the state information in the storage unit 55 and store a new reception time tsb2 in the storage unit 55 (NO in step S51).

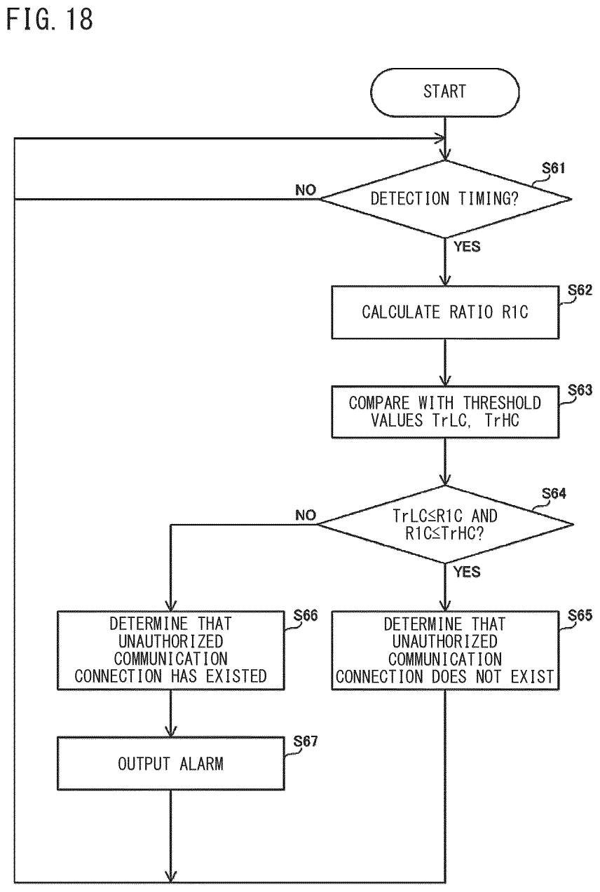

FIG. 18 is a flowchart showing an example of an operation procedure when the relay device according to the embodiment of the present disclosure performs a detection process. FIG. 18 is a flowchart showing the aforementioned specific example 5 of the detection process.

With reference to FIG. 18, the detection unit 53 in the relay device 101 waits for arrival of a detection timing according to a predetermined cycle (NO in step S61). When a detection timing has arrived (YES in step S61), the detection unit 53 calculates a ratio R1C of a connection period T1C to a unit time, based on the reception time tsc1 and the corresponding reception time tec1 stored in the storage unit 55 (step S62).

Next, the detection unit 53 compares the calculated ratio R1C with predetermined threshold values TrLC, TrHC (step S63).

Next, when the ratio R1C is equal to or larger than the threshold value TrLC and the ratio R1A is equal to or smaller than the threshold value TrHC (YES in step S64), the detection unit 53 determines that an unauthorized communication connection does not exist in the network 12 during the period from the previous detection timing to the current detection timing (step S65).

Next, the detection unit 53 waits for arrival of a new detection timing (NO in step S61).

On the other hand, when the ratio R1C is smaller than the threshold value TrLC or the ratio R1C is larger than the threshold value TrHC (NO in step S64), the detection unit 53 determines that an unauthorized communication connection exists in the network 12 during the period from the previous detection timing to the current detection timing (step S66).

Next, the output unit 54 outputs an alarm indicating that an unauthorized communication connection is detected, to the user's terminal or the like (step 67).

Next, the detection unit 53 waits for arrival of a new detection timing (NO in step S61).

In the network 12 according to the embodiment of the present disclosure, the relay device 101 that functions as a detection device is directly connected to the transmission line 14, but the present disclosure is not limited thereto. The detection device may be connected to the transmission line 14 via the communication device 111. In this case, for example, the detection device detects the presence of an unauthorized communication connection by monitoring messages transmitted and received by the communication device 111.

In the network 12 according to the embodiment of the present disclosure, transmission and reception of messages are performed according to TCP/IP, SOME/IP, and DDS, but the present disclosure is not limited thereto. For example, in the network 12, transmission and reception of messages may be performed according to Modbus TCP. In this case, the relay device 101 detects the presence of an unauthorized communication connection by monitoring messages conforming to Modbus TCP which are transmitted and received by the communication device 111.

In the relay device 101 according to the embodiment of the present disclosure, the monitoring unit 52 generates and updates the state information, but the present disclosure is not limited thereto. The monitoring unit 52 may not necessarily generate and update the state information. That is, the monitoring unit 52 may not necessarily monitor the state transition of a communication connection as a monitoring target. In this case, the monitoring unit 52 acquires a reception time ts of a frame in which a specific message is stored, and stores the acquired reception time ts in the storage unit 55. The detection unit 53 detects the presence of an unauthorized communication connection, based on the reception time ts of the specific message.

More specifically, for example, if an SYN packet is stored in a frame received by the relay unit 51, the monitoring unit 52 acquires a reception time tsa1 of this frame, and stores the acquired reception time tsa1 in the storage unit 55 in association with identification information DA. Each time a reception time tsa1 is stored in the storage unit 55 by the monitoring unit 52, the detection unit 53 calculates, as a cycle C1A, a difference between this reception time tsa1 and a reception time tsa1 immediately before the reception time tsa1, and detects the presence of an unauthorized communication connection, based on a plurality of cycles C1A.

If an SYN/ACK packet is stored in a frame received by the relay unit 51, the monitoring unit 52 acquires a reception time tsa2 of this frame, and stores the acquired reception time tsa2 in the storage unit 55 in association with identification information DA. Each time a reception time tsa2 is stored in the storage unit 55 by the monitoring unit 52, the detection unit 53 calculates, as a cycle C1A, a difference between this reception time tsa2 and a reception time tsa2 immediately before the reception time tsa2, and detects the presence of an unauthorized communication connection, based on a plurality of cycles C1A.

If a Subscribe message is stored in a frame received by the relay unit 51, the monitoring unit 52 acquires a reception time tsb1 of this frame, and stores the acquired reception time tsb1 in the storage unit 55 in association with identification information DB. Each time a reception time tsb1 is stored in the storage unit 55 by the monitoring unit 52, the detection unit 53 calculates, as a cycle C1B, a difference between the reception time tsb1 and a reception time tsb1 immediately before the reception time tsb1, and detects the presence of an unauthorized communication connection, based on a plurality of cycles C1B.

Meanwhile, a technology capable of more accurately detecting the presence of an unauthorized communication connection in the network 12 is desired. More specifically, in the conventional technology, if an unauthorized device masquerades as an authorized communication device 111 and establishes an unauthorized communication connection with another communication device 111 by using stateful messages MS, ME, this unauthorized communication connection cannot be detected in some cases.

In contrast to the conventional technology, in the relay device 101 according to the embodiment of the present disclosure, the monitoring unit 52 monitors a communication connection that is established for exchanging a predetermined message in the network 12. The detection unit 53 detects the presence of an unauthorized communication connection, based on a result of monitoring a plurality of communication connections by the monitoring unit 52.

As described above, in the above configuration, the presence of an unauthorized communication connection is detected based on a result of monitoring a plurality of communication connections. Therefore, for example, when the communication connection state in the network 12 has been changed due to establishment of the unauthorized communication connection, it is possible to determine that the unauthorized communication connection exists. Thus, the presence of an unauthorized communication connection in the network 12 can be more accurately detected.

The processes (functions) of the above-described embodiments may be realized by processing circuitry including one or more processors. In addition to the one or more processors, the processing circuitry may include an integrated circuit or the like in which one or more memories, various analog circuits, and various digital circuits are combined. The one or more memories have, stored therein, programs (instructions) that cause the one or more processors to execute the processes. The one or more processors may execute the processes according to the program read out from the one or more memories, or may execute the processes according to a logic circuit designed in advance to execute the processes. The above processors may include a CPU (Central Processing Unit), a GPU (Graphics Processing Unit), a DSP (Digital Signal Processor), an FPGA (Field Programmable Gate Array), an ASIC (Application Specific Integrated Circuit), etc., which are compatible with computer control. The physically separated processors may execute the processes in cooperation with each other. For example, the processors installed in physically separated computers may execute the processes in cooperation with each other through a network such as a LAN (Local Area Network), a WAN (Wide Area Network), or the Internet. The program may be installed in the memory from an external server device or the like through the network. Alternatively, the program may be distributed in a state of being stored in a recording medium such as a CD-ROM (Compact Disc Read Only Memory), a DVD-ROM (Digital Versatile Disk Read Only Memory), or a semiconductor memory, and may be installed in the memory from the recording medium.

The above embodiment is merely illustrative in all aspects and should not be recognized as being restrictive. The scope of the present disclosure is defined by the scope of the claims rather than by the description above, and is intended to include meaning equivalent to the scope of the claims and all modifications within the scope.

The above description includes the features in the additional notes below.

### Additional Note 1

A detection device configured to detect presence of an unauthorized communication connection in a network, comprising:
a monitoring unit configured to monitor a communication connection that is established for exchanging a predetermined message in the network; and
a detection unit configured to detect the presence of the unauthorized communication connection, based on a result of monitoring a plurality of the communication connections by the monitoring unit, wherein
the monitoring unit monitors a first stateful message that is a message for establishing the communication connection, and a second stateful message that is a message for ending the communication connection.

### Additional Note 2

A detection device configured to detect presence of an unauthorized communication connection in a network,
the detection device comprising processing circuitry,
the processing circuitry being configured to:
monitor a communication connection that is established for exchanging a predetermined message in the network, and
detect the presence of the unauthorized communication connection, based on a result of monitoring a plurality of the communication connections.

### REFERENCE SIGNS LIST

14 transmission line
51 relay unit
52 monitoring unit
53 detection unit
54 output unit
55 storage unit
101 relay device
111, 111A, 111B, 111C, 111D, 111E communication device

1. A detection device configured to detect presence of an unauthorized communication connection in a network, comprising:
a monitoring unit configured to monitor a communication connection that is established for exchanging a predetermined message in the network; and
a detection unit configured to detect the presence of the unauthorized communication connection, based on a result of monitoring a plurality of the communication connections by the monitoring unit.

2. The detection device according to claim 1, wherein
the detection unit detects the presence of the unauthorized communication connection, based on a cycle at which the communication connection is established.

3. The detection device according to claim 1, wherein
the detection unit detects the presence of the unauthorized communication connection, based on a frequency at which the communication connection is established.

4. The detection device according to claim 1, wherein
the detection unit detects the presence of the unauthorized communication connection, based on a ratio of a period during which the communication connection is established, to a unit time.

5. The detection device according to claim 1, wherein
the monitoring unit monitors the communication connection that is established by using a Subscribe Ack message conforming to SOME/IP (Scalable service-Oriented MiddlewarE over IP), and is ended by using a Stop Offer message or a Stop Subscribe message conforming to SOME/IP.

6. The detection device according to claim 1, wherein
the monitoring unit monitors a TCP (Transmission Control Protocol) connection as the communication connection.

7. The detection device according to claim 1, wherein
the monitoring unit monitors the communication connection that is established by using a create_subscriber message conforming to DDS (Data Distribution Service), and is ended by using a Delete_subscriber message conforming to DDS.

8. A detection method in a detection device that detects presence of an unauthorized communication connection in a network, the method comprising:
monitoring a communication connection that is established for exchanging a predetermined message in the network; and
detecting the presence of the unauthorized communication connection, based on a result of monitoring a plurality of the communication connections.

9. A non-transitory computer-readable storage medium having, stored therein, a detection program used in a detection device that detects presence of an unauthorized communication connection in a network,
the program causing a computer to function as:
a monitoring unit configured to monitor a communication connection that is established for exchanging a predetermined message in the network; and
a detection unit configured to detect the presence of the unauthorized communication connection, based on a result of monitoring a plurality of the communication connections by the monitoring unit.

10. The detection device according to claim 1, wherein
the monitoring unit monitors at least one of a first stateful message that is a stateful message for establishing the communication connection, and a second stateful message that is a stateful message for ending the communication connection, and
the detection unit detects the presence of the unauthorized communication connection, based on a reception time of the stateful message in the network.
